(19) United States
(12) Patent Application Publication
(10) Pub. No.: US 2012/0303796 A1
(43) Pub. Date: Nov. 29, 2012

(54) MAPPING ACCOUNTING AVPS TO MONITORING KEYS FOR WIRELINE SUBSCRIBER MANAGEMENT

(75) Inventors: Fan Mo, Ottawa (CA); Pradeep Mekala, Nepean (CA); Justin Newcomb, Kanata (CA)

(73) Assignee: Alcate-Lucent Canada Inc., Ottawa (CA)

(21) Appl. No.: 13/117,357

(22) Filed: May 27, 2011

(51) Int. Cl. G06F 15/173

(52) U.S. Cl. 709/224

(57) ABSTRACT

Various exemplary embodiments relate to a session management node. A session management node may include: a receiver that receives an accounting message indicating network usage of a subscriber, the message including at least one field; a NAS profile that maps the accounting message to a type of usage based on the field; a session information storage that includes a record of accumulated network usage for the type of usage; and a usage reporter that updates the subscriber's accumulated network usage. Various exemplary embodiments relate to a method of measuring network usage of a subscriber. The method may include: receiving an accounting message; determining a type of usage; and monitoring the subscriber's usage according to the type of usage. In various exemplary embodiments, various messages including vendor specific fields may be mapped to the same type of usage. A rating factor for monitoring may be assigned to a type of usage.

CROSS-REFERENCE

This application cross-references the following co-pending application, incorporated by reference herein: Application Ser. No. [To be determined], Attorney Docket No. ALC 3709, “QOS CONTROL IN WIRELINE SUBSCRIBER MANAGEMENT” to Mo et al.

### TECHNICAL FIELD

Various exemplary embodiments disclosed herein relate generally to telecommunications.

### BACKGROUND

A communications network may provide subscribers with access to network resources. A Network Access Server (NAS) may control a subscriber's access to the communications network. A subscriber may establish a session with the NAS for transferring data packets to the communications network. Subscribers may obtain a variety of services from the communications network such as, for example, web browsing, file downloads, online storage, streaming music or video, voice over Internet Protocol (VoIP), or other services provided by the Internet.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a session management node. A session management node may include: a receiver configured to receive, from a network access server (NAS), an accounting message that indicates a network usage of a subscriber, the accounting message including at least one field; a NAS profile configured to map the accounting message to a type of usage based on the at least one field; a session information storage that includes a record of an accumulated network usage of the subscriber, the record including accumulated usage for the type of usage; and a usage reporter configured to update the subscriber's accumulated network usage in the session information storage for the type of usage corresponding to the accounting message.

Various exemplary embodiments relate to a method of measuring network usage of a subscriber. The method may include: receiving, at a session management node, from a Network Access Server (NAS), an accounting message that indicates an amount of network usage of a subscriber, the accounting message including at least one field; determining a type of usage based on the at least one field using a NAS profile; and monitoring the usage of the subscriber by adding the amount of network usage to an accumulated usage for the type of usage for the subscriber.

Various exemplary embodiments relate to a machine-readable storage medium encoded with instructions for measuring network usage of a subscriber. The machine-readable storage medium may include: instructions for receiving, at a session management node, from a Network Access Server (NAS), an accounting message that indicates an amount of network usage of a subscriber, the accounting message including at least one field; instructions for determining a type of usage based on the at least one field using a NAS profile; and instructions for monitoring the usage of the subscriber by adding the amount of network usage to an accumulated usage for the type of usage for the subscriber.

In various alternative embodiments, the accounting message may be a RADIUS Accounting-Request message and the at least one field may be at least one AVP. The at least one AVP may be a Vendor-Specific AVP including a Vendor-Id field and an attribute specific field, and the NAS profile be configured to map the accounting message to a monitoring key based on the attribute specific field. The attribute specific field may indicate a Quality of Service (QoS) that the NAS provided for the network usage of the subscriber.

In various alternative embodiments, the receiver may be configured to receive at least one accounting message from each of at least two different NAS servers; and the NAS profile may be configured to map the accounting message from each NAS server to the same type of usage based on a different field in each accounting message.

In various alternative embodiments the type of usage may be associated with a monitoring key. The monitoring key may be associated with at least one threshold amount of usage for the type of usage and a policy to be applied if the subscriber's accumulated network usage exceeds the threshold. The monitoring key may be associated with a rating factor, and the usage reporter may be configured to multiply the network usage of the subscriber by the rating factor. in various alternative embodiments, the rating factor may be increased based on a current time period.

In various alternative embodiments, the type of usage may be associated with a monitoring key corresponding to a threshold amount of usage and a policy to be applied if the subscriber's accumulated usage exceeds the threshold. The method of measuring subscriber usage may also include: if the accumulated usage for the type of usage for the subscriber exceeds the threshold amount of usage for the monitoring key, applying the policy for the monitoring key to the subscriber; authorizing a QoS for the subscriber based at least on the policy applied to the subscriber; and transmitting an authorization message to the NAS indicating the QoS that the NAS should provide to the subscriber. The step of determining a type of usage may include: identifying the NAS that sent the accounting request; identifying a field among the at least one field that indicates a type of usage based on the identified NAS; determining whether the field is a vendor specific field; and if the field is a vendor specific field: identifying the vendor of the identified NAS, and determining the monitoring key based on the vendor and a sub-field of the vendor specific field.

### BRIEF DESCRIPTION OF THE DRAWINGS

In order to better understand various exemplary embodiments, reference is made to the accompanying drawings, wherein:

FIG. 1 illustrates an exemplary network system with Network Access Servers (NAS) controlled by a session management node;

FIG. 2 illustrates an exemplary session management node;

FIG. 3 illustrates an exemplary data structure for storing a metering policy;

FIG. 4 illustrates exemplary data structure for storing QoS rules;

FIG. 5 illustrates a flowchart showing an exemplary method for authorizing Quality of Service (QoS) for a subscriber session;

FIG. 6 illustrates an exemplary accounting request message;

FIG. 7 illustrates an exemplary data structure for storing NAS profiles; and

FIG. 8 illustrates a flow chart showing an exemplary method for determining a monitoring key.

### DETAILED DESCRIPTION

Wireline subscriber networks were thought to provide sufficient speed and bandwidth to provide subscribers with a desired QoS without detailed session QoS management integrated with subscriber usage and time of day information. Newer services, however, may consume greater bandwidth and require minimal delay. Some subscribers who use the network heavily may create network congestion, preventing other subscribers from receiving their desired QoS. A similar problem may occur during certain time periods when many users attempt to receive high bandwidth services. It would therefore be desirable to provide a system and method allowing a network operator to manage the QoS of a subscriber based on the amount and type of a subscriber's usage and a current time period.

Referring now to the drawings, in which like numerals refer to like components or steps, there are disclosed broad aspects of various exemplary embodiments.

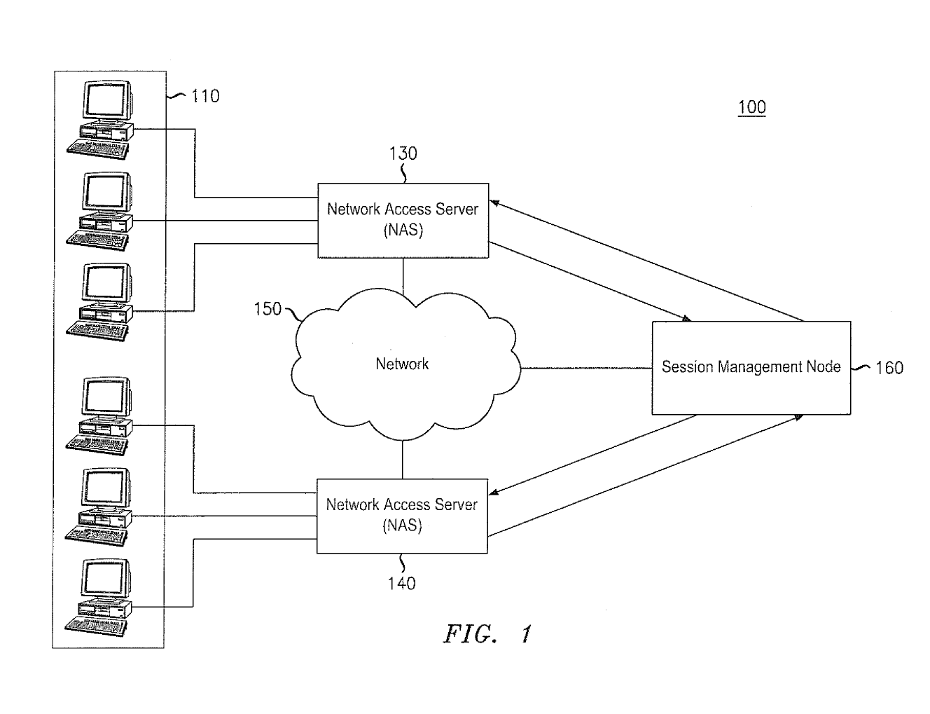

FIG. 1 illustrates an exemplary network system 100 with Network Access Servers (NAS) 130, 140 controlled by a session management node 160. Network system 100 may include subscriber equipment devices 110, NAS nodes 130 and 140, network 150, and session management node 160.

Each of subscriber equipment devices 110 may be any device or equipment used by a subscriber to access a network via a NAS. Subscriber equipment devices 110 may include, for example, desktop computers, laptop computers, VoIP phones, DSL modems, cable modems or any other device that connects to a network. Generally, the subscriber equipment devices 110 may access the NAS via a wireline connection such as, for example, dial-up, Digital Subscriber Line (DSL), cable, Ethernet, or other wired technologies. It should be recognized, however, that subscriber equipment 110 may connect via a partially or fully wireless connection such as, for example, a local wireless router. A subscriber may use subscriber equipment 110 to obtain services such as, for example, web browsing, data transfer, streaming video, or voice over IP (VoIP) from network 100. Different devices included within subscriber equipment 110 may obtain services through different NAS nodes such as, for example NAS 130 and NAS 140. For example, NAS 130 may provide Internet access, and NAS 140 may provide on-demand streaming video.

Network Access Server (NAS) 130 may be any server that provides network access for subscriber equipment 110. NAS 130 may provide network access to subscriber equipment 110 by establishing a session with the subscriber equipment 110. NAS 130 may forward packets between subscriber equipment 110 and network 150. It should be recognized that one or more other servers, routers or switches may be located between NAS 130 and network 150. NAS 130 may provide network access for more than one piece of subscriber equipment 110. NAS 130 may implement a Quality of Service (QoS) for network connections to subscriber equipment 110. As used herein, QoS may refer to various parameters such as, for example, bandwidth, priority, delay or other characteristics of a network connection to subscriber equipment 110. NAS 130 may use packet filters or packet filter rules received from session management node 160 to control the QoS of a network connection. By filtering packets, NAS 130 may control which services a subscriber may access and how packets for various services are treated.

NAS 130 may send accounting messages to a session management node 160. Accounting messages may describe a subscriber's usage of the network with subscriber equipment 110. Accounting messages may include an identification of the subscriber, connection, or device and a usage amount. The identification may be, for example, an account name, session number, IP address, or MAC address. Usage amount may be measured in, for example, bits, bytes, octets, packets, units of time, or a percentage of a set amount. NAS 130 may use the RADIUS protocol to send accounting messages to session management node 160. A RADIUS accounting message may include one or more attribute value pairs (AVPs) indicating a type and value for data. NAS 130 may use vendor-specific AVPs to report usage information.

NAS 140 may be similar to NAS 130. Network 100 may include multiple NASs corresponding to either NAS 130 or NAS 140. NAS 140 may perform similar functions to NAS 130. NAS 140 may provide a network connection to a different set of user equipment 110. In some embodiments, NAS 140 may be provided by a different vendor, be a different model, or otherwise differ from NAS 130. In these embodiments, NAS 140 may provide different accounting messages than NAS 130. Accounting messages may, for example, use different AVPs, measure values differently, relate to different events, or include vendor-specific AVPs. It should be noted that, while exemplary network includes two NAS devices, the methods described herein may be implemented in networks utilizing any number of NAS devices.

Network 150 may include any network of computing devices. Network 150 may provide computing services or data to users who connect through a NAS. Network 150 may include Internet Service Provider (ISP) network resources such as servers, routers, switches, wires, cables, fibers, wireless equipment and any other hardware used to provide connections or deliver data.

Session management node 160 may be a server that manages one or more NASs, such as, for example, NAS 130 and NAS 140. Session management node 160 may communicate with NAS 130 by exchanging messages. Messages may be transmitted via network 150 or carried through a private network connection. In various exemplary embodiments, session management node 160 may use the RADIUS protocol to communicate with NAS 130. Session management node 160 may receive accounting messages including AVPs from NAS 130. Session management node 160 may interpret the accounting messages and AVPs to extract usage information about subscribers. Session management node 160 may authorize a QoS for a subscriber based on usage information collected from NAS 130. For example, session management node 160 may authorize a lower QoS if accumulated usage information indicates that the subscriber has exceeded a threshold for a particular type of usage, that is, if the subscriber has used the network too much. Session management node 160 may also base the authorized QoS on other information such as, for example, a current time period, a subscriber contract, and network congestion. Session management node 160 may provide the authorized QoS to NAS 130. In various exemplary embodiments, the QoS may be in the form of a selected packet filter as indicated by an AVP within a RADIUS message sent to NAS 130.

Having described the components of network system 100, a brief example of the operation of network system 100 will now be provided. A subscriber may seek to establish a session between one of subscriber equipment 110 and NAS 130 to obtain network access. NAS 130 may request a QoS for the session from session management node 160. Session management node 160 may authorize a QoS based on any stored usage information for the subscriber and a current period of time. Session management node 160 may then send an authorization message to NAS 130 including the authorized QoS. NAS 130 may monitor the usage of the subscriber and send accounting messages to session management node 160. Session management node 160 may interpret the accounting messages and record the subscriber's usage. Session management node 160 may reauthorize the QoS for the subscriber's session based on the subscriber's usage or a change in the current time period. For example, the subscriber may cross a usage threshold, resulting in a lower authorized QoS. The current time period may also change, resulting in a lower or greater authorized QoS.

A similar process may occur for a second subscriber seeking to access the network through NAS 140. Session management node 160 may provide NAS 140 with an authorized QoS. NAS 140 may also report the subscriber's usage using accounting messages. Even if the accounting messages from NAS 140 are different than the messages from NAS 130, session management node 160 may determine that they report the same type of usage. Thus, session management node 160 may track usage independently of the NAS. Session management node 160 may also reauthorize the second subscriber's QoS based on usage and current time period. In this manner, session authorization node 160 may control the authorized QoS for numerous subscribers accessing the network through different NAS nodes.

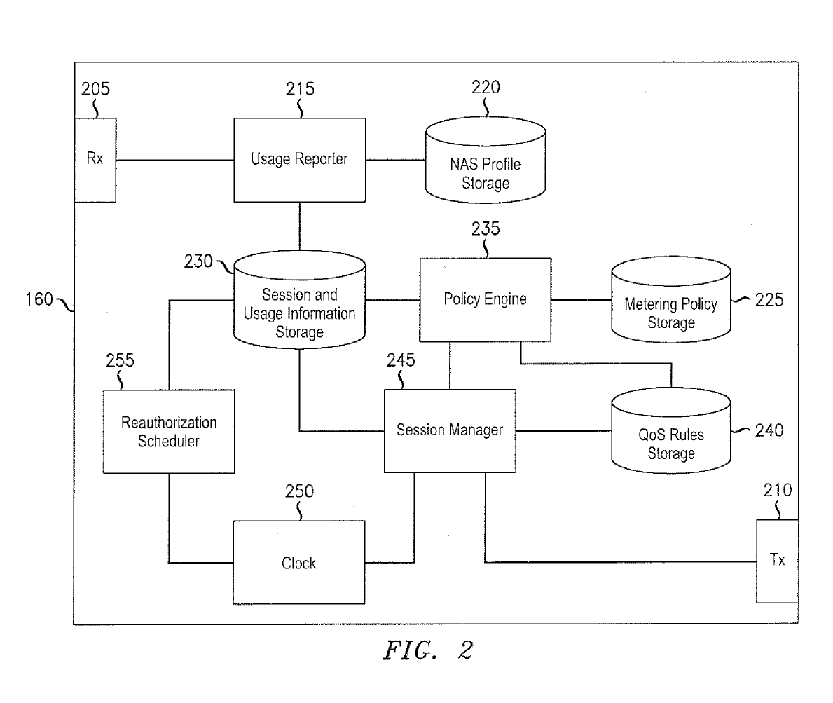

FIG. 2 illustrates an exemplary session management node 160. Session management node 160 may operate as described above regarding FIG. 1. Session management node 160 may include receiver 205, transmitter 210, usage reporter 215, NAS profile storage 220, metering policy storage 225, session information storage 230, policy engine 235, QoS rules 240, session manager 245, clock 250, and reauthorization scheduler 255.

Receiver 205 may receive messages transmitted to session management node 160 via network 150 or a private network connection. Receiver 205 may be, for example, a network card or network interface controller. In various exemplary embodiments, receiver 205 may ensure that received messages comply with a communications protocol used by session management node 160, for example, RADIUS protocol. Receiver 205 may identify accounting messages including usage information and forward the accounting messages to usage reporter 215. Receiver 205 may also receive confirmation messages indicating that a network component has received a message sent by session management node 160.

Transmitter 210 may transmit messages to other network components such as NAS 130. Transmitter 210 may be, for example, a network card or network interface controller. In various exemplary embodiments, transmitter 210 may ensure that sent messages comply with a communications protocol used by session management node 160, for example, RADIUS protocol. In various embodiments, transmitter 210 may transmit change of authorization—request (CoA-Request) messages including a packet filter or packet filter rules describing an authorized QoS. Transmitter 210 may also transmit confirmation messages to indicate that session management node 160 has received a message sent by another network component. It should be understood that receiver 205 and transmitter 210 may be the same device. For example, receiver 205 and transmitter 210 may be the same networking card within session management node 160. Alternatively, session management node 160 may include multiple cards or circuits that perform the functions of receiver 205 and transmitter 210. Session management node 160 may include multiple receivers 205 or multiple transmitters 210.

Usage reporter 215 may interpret received accounting messages and track the network usage of subscribers. Upon receiving an accounting message, usage reporter 215 may query NAS profile storage 220 with the identity of the NAS that sent the message and information about the message. The query may include content within the message such as an attribute value pairs (AVP). In response, usage reporter 215 may receive a monitoring key from NAS profile storage 220 that indicates a type of usage of the subscriber. Usage reporter 215 may also receive a rating factor from NAS profile storage 220. Usage reporter 215 may update information in session information storage 230 based on the received message. Usage reporter 215 may add the amount of usage included in the accounting message to a stored accumulated usage for the subscriber according to the monitoring key. In various exemplary embodiments, usage reporter 215 may multiply the amount of usage included in the accounting message by the rating factor. For example, usage reporter 215 may add the amount of usage to a VIDEO monitoring key when the subscriber finishes watching a streaming video. If the VIDEO monitoring key is associated with a rating factor of 3, usage reporter 215 may multiply the amount of usage by 3 before adding it to the stored accumulated usage. In various alternative embodiments, the rating factor may not be used when the usage is accumulated, but may be used when comparing usage of different monitoring keys or determining total usage. Usage reporter 215 may also periodically reset the stored usage for a subscriber, for example, at the start of a monthly billing cycle. Resetting the stored usage may reduce the subscriber's usage to zero. Other values may be possible after the reset based on the subscriber's contract.

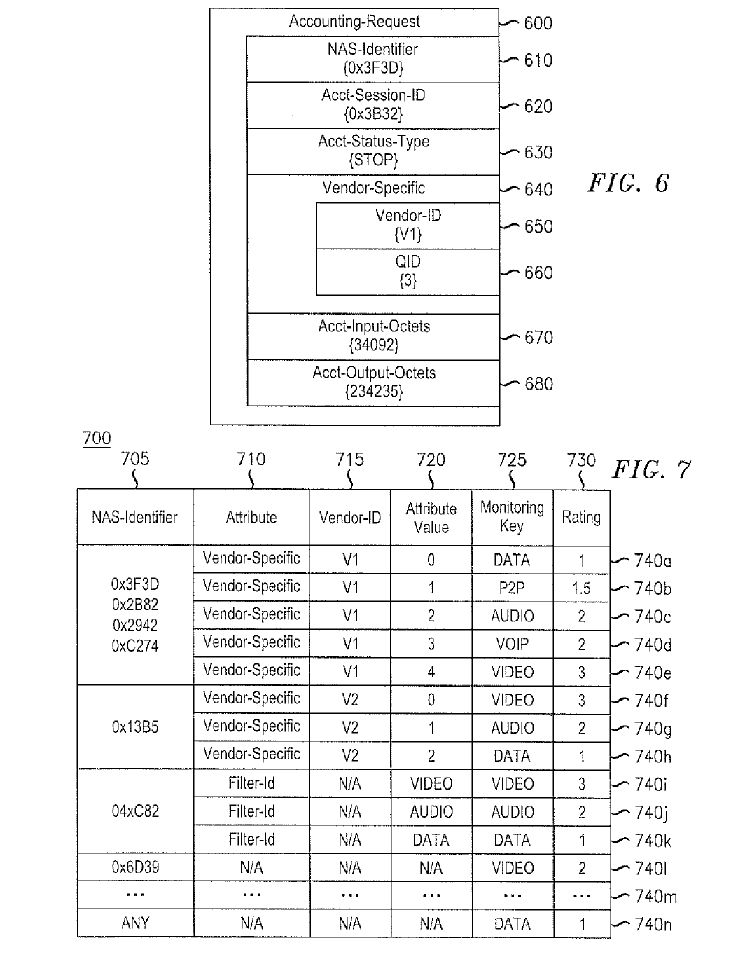

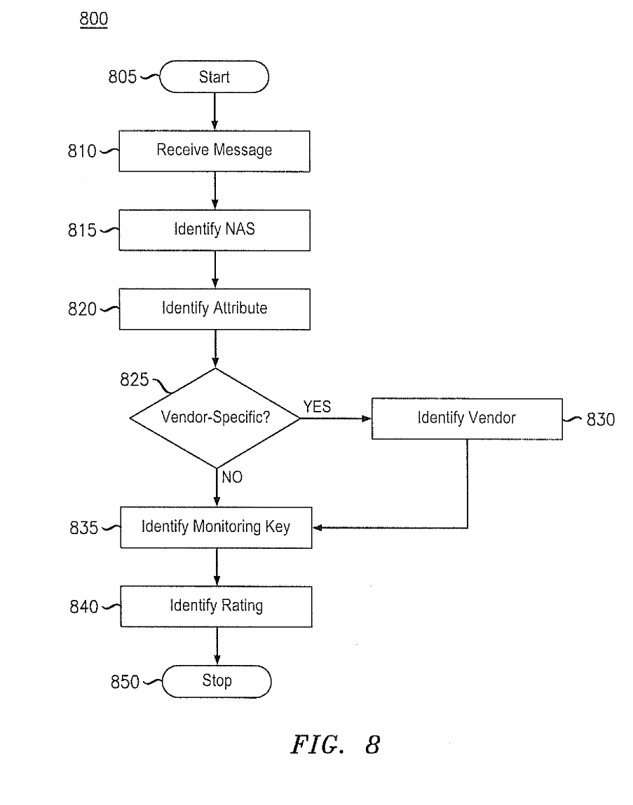

NAS profile storage 220 may include a configurable mapping of NAS accounting messages to monitoring keys. NAS profile storage 220 may include a data structure such as, for example, data structure 700, which is described in detail below regarding FIG. 7. In various exemplary embodiments, NAS profile storage 220 may map AVPs to monitoring keys. Each monitoring key may be associated with a type of usage. The configurable mapping may allow the operator of the session management node to designate different services or types of service that are tracked by the same monitoring key. For example, one monitoring key may relate to a type of video service such as, for example, streaming video, IPTV, and/or video conference. Alternatively, a monitoring key may relate to any type of video service. As another example, a second monitoring key may relate to a type of audio service such as, for example, streaming music and/or VoIP. Alternatively, a monitoring key may relate to any type of audio service. For either example, NAS profile storage 220 may include a mapping from an AVP indicating use of the service to the monitoring key associated with the service. As described above in relation to NAS 140, session management node 160 may receive accounting messages using different and/or vendor-specific AVPs. Therefore, in various embodiments, NAS profile storage 220 may include multiple AVPs mapped to the same monitoring key.

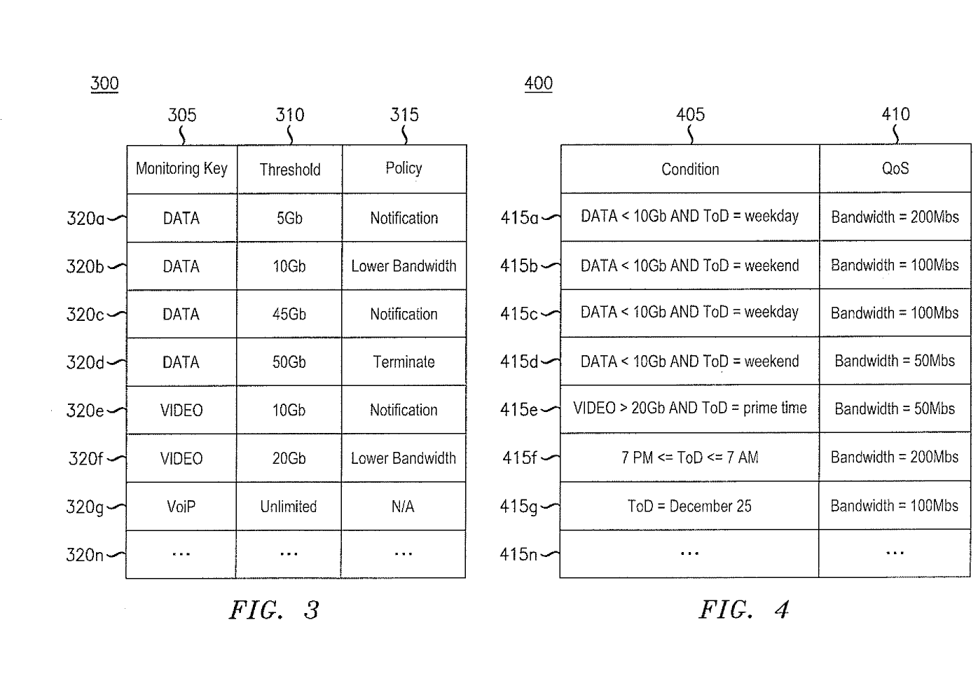

Metering policy storage 225 may store metering policy information. A metering policy may be associated with each monitoring key. As will be described in further detail below in relation to FIG. 3, metering policy storage 225 may include a set of thresholds associated with a monitoring key. A metering policy may also define a policy or action associated with a threshold. The metering policy storage 225 may be used by policy engine 235 to determine what action to take when a subscriber's usage exceeds a threshold associated with a monitoring key.

Session information storage 230 may store information regarding subscriber sessions and network usage. In particular, session information storage 230 may include one or more entries for each subscriber corresponding to a monitoring key and indicating an amount of usage for the subscriber associated with the monitoring key. Usage reporter 215 may update the entries of session information storage 230 as it receives accounting messages. Policy engine 235 may compare the entries of session information storage 230 with the thresholds of a metering policy to determine whether to take a management action. Session information storage 230 may also include other information useful for managing subscriber sessions. For example, session information storage 230 may include a reauthorization time, a rollover date, subscriber contact and billing information or any other information related to the subscriber or session. Session information storage 230 may also be accessible to policy engine 235, session manager 245, and reauthorization scheduler 255. Session information storage 230 may use a cache to store session information that is likely to be accessed frequently. For example, the cache may store session information for highly active sessions and sessions that are approaching a reauthorization time.

Policy engine 235 may determine whether to apply a metering policy based on the stored current usage. Policy engine 235 may query metering policy storage 225 to determine a policy to be applied to the monitoring key. Policy engine 235 may compare the current usage with a threshold value included in the metering policy. If the current usage exceeds the threshold value, policy engine 235 may perform a management action indicated in the metering policy. Exemplary management actions that may be included in a metering policy may include, for example: sending notification to the subscriber, adjusting the subscriber's QoS, and/or terminating the subscriber's session. Policy engine 235 may send notification to the customer by generating an e-mail, text message, or other communication method. The notification may include the current usage, the exceeded threshold, other thresholds associated with the monitoring key, or any other information about the subscriber or network service. Policy engine 235 may adjust the QoS of the subscriber by changing QoS rules storage 240 and triggering session manager 245. Likewise, policy engine 235 may terminate the subscriber's session by changing QoS rules storage 240 and triggering session manager 245. Alternatively, policy engine 235 may implement a policy by changing flags or other data to ensure that an existing rule will be applied to a subscriber.

QoS rules storage 240 may store a configurable set of rules for determining the QoS that may be authorized for a subscriber. As will be described in further detail below regarding FIG. 4, QoS rules storage 240 may include one or more conditions and a QoS to be authorized if the conditions are met. Policy engine 235 may modify QoS rules 240 if policy engine 235 determines that a subscriber's usage has exceeded a threshold associated with a monitoring key. Alternatively, QoS rules storage 240 may include conditions corresponding to various monitoring key thresholds. Session manager 245 may use QoS rules storage 240 when determining the QoS that should be authorized for a subscriber session.

Session manager 245 may determine an appropriate QoS to authorize for a subscriber session. Session manager 245 may base the authorized QoS on several factors, including, but not limited to: subscriber usage information, metering policy thresholds, subscriber agreements, current period of time, and/or network congestion. Session manager 245 may use QoS rules storage 240 to determine the authorized QoS. Session manager 245 may authorize a QoS for a subscriber session when the subscriber's current session is about to expire as indicated by a session reauthorization time in session information storage 230. Session manager 245 may also authorize a QoS whenever policy engine 235 detects that the subscriber's usage has exceeded a threshold, when the current time period changes, when a subscriber restarts a session, or when the operator triggers reauthorization.

Clock 250 may provide session management node 160 with the current time. The current time may be used to determine a current time period which may affect the authorized QoS. The current time period may relate to a time of day, a day of the week, set of days, or any other interval of time. For example, different QoS rules may be applied depending on whether the current time period is daytime, night, or weekend. The current time may also be used by reauthorization scheduler 255 to determine when to reauthorize the QoS for the session.

Reauthorization scheduler 255 may determine when a session requires reauthorization. Reauthorization scheduler 255 may determine which sessions require reauthorization by comparing a reauthorization time in session information storage 230 to the current time. A session may require reauthorization when it has expired or is about to expire. Reauthorization scheduler 255 may also require reauthorization when clock 250 indicates that the current time period has changed. When reauthorization scheduler 255 determines that a session must be reauthorized, session manager 245 may determine a new QoS for the session.

FIG. 3 illustrates an exemplary data structure 300 for storing a metering policy. Although data structure 300 is shown as a table, it should be apparent that other data structures for storing similar data may be used. Data structure 300 may include fields for monitoring key 305, threshold 310, and policy field 315. Data structure 300 may include one or more entries 320a . . . n for storing data. Data structure 300 may be stored in a machine-readable storage medium of session management node 160, such as, for example metering policy storage 225. The operator of session management node 160 may configure the entries of data structure 300.

Monitoring key field 305 may identify a monitoring key. As described above with regard to NAS profile storage 220, one or more accounting messages or AVPs within an accounting message may be mapped to a monitoring key. A session management node operator may configure monitoring key field 305 with entries that correspond to types of services. Each monitoring key may be associated with a rating factor. A subscriber's usage associated with a monitoring key may be multiplied by the rating factor.

Threshold field 310 may identify a usage amount associated with a monitoring key. An entry may specify threshold field 310 using an appropriate unit such as, for example, bits, bytes, packets, units of time, or a percentage of another identified value. Several entries 320 may identify different thresholds for a monitoring key field 305.

Policy field 315 may identify a policy to be applied or a management action to be taken if a subscriber's usage of a monitoring key 305 exceeds a threshold 310. Entries 320 for policy field 315 may include, for example, sending notification to the subscriber, adjusting the QoS of the subscriber, and/or terminating the subscriber's session.

Several examples of entries 320 in data structure 300 will now be described. Entry 320a may correspond to a DATA monitoring key with a threshold of 5 Gb and a policy of notification. Entry 320b may correspond to the DATA monitoring key with a threshold of 10 Gb and a policy of lower bandwidth. Entry 320c may correspond to the DATA monitoring key with a threshold of 45 Gb and a policy of notification. Entry 320d may correspond to the DATA monitoring key with a threshold of 50 Gb and a policy of terminate. Thus, in this example, entries 320a-d may specify a policy for DATA where the subscriber's QoS is reduced after 10 Gb of usage and terminated after 50 Gb. The subscriber may be notified of the upcoming policy actions when the thresholds of 5 Gb and 45 Gb are crossed. Entry 320e may correspond to a VIDEO monitoring key with a threshold of 10 Gb and a policy of notification. Entry 320f may correspond to the VIDEO monitoring key with a threshold of 20 Gb and a policy of lower bandwidth. Thus, in this example, entries 320e-f may specify a policy for VIDEO where the subscriber receives notification at 10 Gb and the QoS is reduced at 20 Gb of usage. Entry 320g may correspond to a VoIP monitoring key with no threshold and no policy. Accordingly, the QoS may not change due to VoIP usage. Entry 320n may indicate that any number of additional entries may be included in data structure 300.

FIG. 4 illustrates an exemplary data structure 400 for storing QoS rules. Although data structure 400 is shown as a table, it should be apparent that other data structures for storing similar data may be used. Data structure 400 may include fields for condition 405 and QoS 410. Data structure 400 may include one or more entries 415a . . . n for storing data. Data structure 400 may be stored in a machine-readable storage medium of session management node 160, for example, QoS rules storage 240. The operator of session management node 160 may configure the entries of data structure 400. Alternatively, the entries of data structure 400 may be configured automatically based on metering policy storage 225.

Condition field 405 may indicate one or more conditions that must be satisfied for the rule to apply to a subscriber. Condition field 405 may include a condition based on metering policy storage 225, session information storage, the current time period, and/or other information.

QoS field 410 may indicate a QoS that may be authorized for the subscriber. QoS field 410 may include bandwidth, delay, priority, shaping, and/or blocking characteristics. In various exemplary embodiments, QoS may be indicated by a packet filter or packet filter rules. A QoS in the form of a packet filter or packet filter rules may be easily implemented by NAS 130.

Several examples of entries 415 in data structure 400 will now be described. In these examples, a bandwidth is listed as the authorized QoS; however, as discussed above, other QoS characteristics or a combination thereof may be used. Entry 415a may include a condition that is satisfied when the subscriber's usage of the DATA monitoring key is less than 10 Gb and the current time period is a weekday. Entry 415a may indicate that the subscriber is authorized for a QoS including a 200 Mbs bandwidth. Entry 415b may include a condition that is satisfied when the subscriber's usage of the DATA monitoring key is less than 10 Gb and the current time period is a weekend. Entry 415b may indicate that the subscriber is authorized for a QoS including a 100 Mbs bandwidth. Entry 415c may include a condition that is satisfied when the subscriber's usage of the DATA monitoring key is greater than 10 Gb and the current time period is a weekday. Entry 415c may indicate that the subscriber is authorized for a QoS including a 100 Mbs bandwidth. Entry 415d may include a condition that is satisfied when the subscriber's usage of the DATA monitoring key is greater than 10 Gb and the current time period is a weekend. Entry 415d may indicate that the subscriber is authorized for a QoS including a 50 Mbs bandwidth. Entry 415e may include a condition that is satisfied when the subscriber's usage of the VIDEO monitoring key is greater than 20 Gb and the current time period is prime time. Entry 415e may indicate that the subscriber is authorized for a QoS including a 50 Mbs bandwidth. Entry 415f may include a condition that is satisfied when the current time period is between 7 PM and 7 AM. Entry 415f may indicate that the subscriber is authorized for a QoS including a 200 Mbs bandwidth. Entry 415g may include a condition that is satisfied when the current time period is December 25 Entry 415g may indicate that the subscriber is authorized for a QoS including a 100 Mbs bandwidth. Entry 415n may indicate that any number of entries in data structure 400 is possible. It should be recognized that an operator of session management node 160 may create more elaborate sets of rules with conditions based on usage of monitoring keys and current time period to fulfill subscriber service contracts and manage network resources.

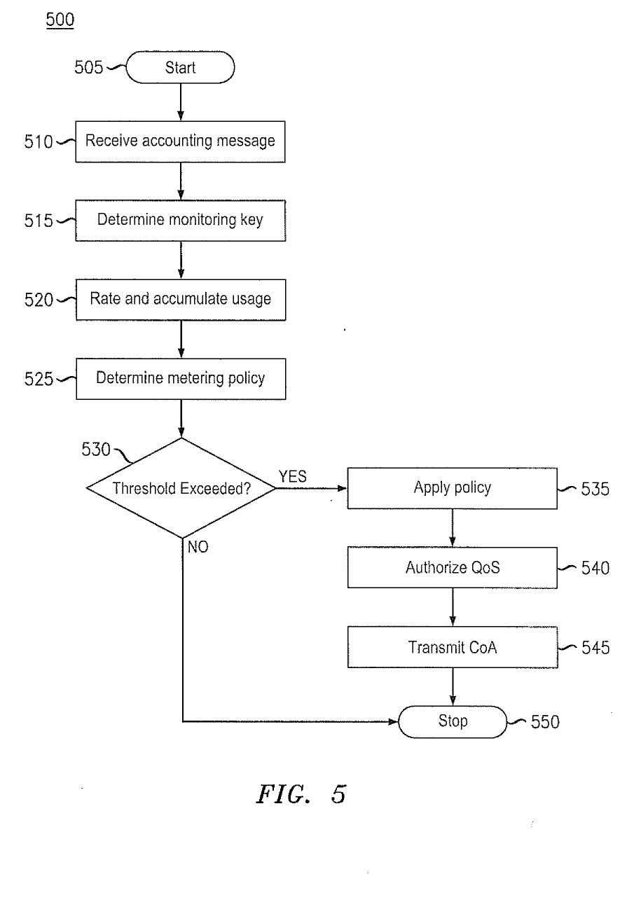

FIG. 5 illustrates a flowchart showing an exemplary method 500 for authorizing Quality of Service (QoS) for a subscriber session. The method 500 may be performed by the various components of session management node 160 such as receiver 205, transmitter 210, usage reporter 215, policy engine 235, session manager 245, clock 250 and/or reauthorization scheduler 255. The method 500 may begin in step 505 and proceed to step 510.

In step 510, session management node 160 may receive an accounting message at receiver 205. The accounting message may be from, for example, NAS 130. An exemplary accounting message will be described in greater detail below regarding FIG. 6. Session management node 160 may confirm that the message is in an appropriate format upon receipt. The method 500 may then proceed to step 515.

In step 515, session management node 160 may determine the monitoring key by querying NAS profile storage 220. Session management node 160 may compare a specific AVP within the accounting message that purports to identify a service type with contents of NAS profile storage 220. Alternatively, session management node 160 may compare multiple AVPs such as, for example, an NAS identifier and service type, with the NAS profile. Session management node 160 may also determine a rating factor based on the accounting message and NAS profile storage 220.

In step 520, session management node 160 may add the reported usage from the received accounting message to a stored value in session information storage. Session management node 160 may determine the reported usage from the received message by extracting the value from an AVP in the message. Alternatively, session management node 160 may determine the reported usage by comparing start and stop times of the session. Session management node 160 may also ensure that the value for the reported usage is expressed in an appropriate unit. Session management node 160 may then locate the entry in session information storage corresponding to the subscriber and the monitoring key. Session management node 160 may add the reported usage to the stored value and store the result. In various alternative embodiments, session management node 160 may multiply the reported usage by a rating factor associated with the monitoring key before adding and storing the value. The method 500 may then proceed to step 530.

In step 525, session management node 160 may retrieve the metering policy associated with the monitoring key. In various embodiments, the metering policy may depend on both the monitoring key and subscriber information such as, for example, a service agreement. Multiple policies associated with a monitoring key may allow a service provider to offer different service plans or premium services.

In step 530, session management node 160 may determine whether the subscriber's usage has exceeded a threshold. Session management node 160 may compare the newly stored value for a monitoring key to the threshold of the monitoring key in the metering policy. If the stored value exceeds the threshold, the method 500 may proceed to step 535. Otherwise, the method may proceed to step 550, where the method ends.

In step 535, session management node 160 may apply the metering policy corresponding to the exceeded threshold. Session management node 160 may notify the subscriber by generating an email or other communication. The notification may include the stored value for the subscriber's monitoring key and the threshold that was crossed. The notification may further include one or more other thresholds associated with the monitoring key and the policy that will be applied if the thresholds are exceeded. Session management node 160 may change the QoS that will be authorized for the subscriber session. Session management node 160 may alter QoS rules storage 240 to change the QoS. For example, session management node 160 may add an additional rule authorizing a lower QoS for subscribers that have exceeded a threshold. Alternatively, QoS rules storage 240 may already include the appropriate rule and session management node 160 may ensure that the appropriate rule is applied by changing a flag or other value associated with the subscriber. Session management node 160 may terminate a subscriber session using QoS rules that don't authorize a session. Alternatively, session management node 160 may terminate a session by updating the session information storage and sending a disconnect message.

In step 540, session management node 160 may authorize a QoS for a subscriber session. Session management node 160 may check the conditions for each rule within QoS rules storage 240. When session management node 160 finds a rule where all the conditions are met, it may authorize the QoS of the rule for the subscriber session. Session management node 160 may update session information storage to include the authorized QoS and a session reauthorization time. The method 500 may then proceed to step 545.

In step 545, session management node 160 may transmit a CoA message including the authorized QoS. The authorized QoS may be an AVP indicating a packet filter to be applied at the NAS to packets within the subscriber's session. Alternatively, the authorized QoS may be a set of packet filter rules to be applied at the NAS to packets within the subscriber's session. Session management node 160 may receive a confirmation that the CoA was received. Session management node 160 210 may retransmit the CoA if the confirmation is not received. The method 500 may then proceed to step 550, where the method ends.

FIG. 6 illustrates an exemplary accounting request message 600. Message 600 may be, for example, a RADIUS Accounting-Request message. Other protocols using fields and/or AVPs such as, for example, Diameter protocol may also be used for accounting request messages. Message 600 may provide usage information from, for example, NAS 130 to session management node 160. Message 600 may include one or more fields and/or AVPs. Message 600 may include: NAS-Identifier AVP 610, Acct-Session-ID AVP 620, Acct-Status-Type AVP 630, Vendor-Specific AVP 640, Vendor-ID field 650, QID field 660, Acct-Input-Octets AVP 670, and Acct-Output-Octets AVP 680. Message 600 may also include one or more additional fields and/or AVPs (not shown).

NAS-Identifier AVP 610 may be an AVP that identifies the NAS that sent the accounting message. For example, message 600 may have been sent by a NAS with the name “0x3F3D.” In various alternative embodiments, the NAS may be identified by an IP address.

Acct-Session-ID 620 AVP may be an AVP that identifies the account session for which the accounting message is providing usage information. For example, message 600 may be for a session identified as “0x3B32.” The Acct-Session-ID AVP 620 may be used to identify the subscriber for whom the accounting message provides usage information.

Acct-Status-Type 630 AVP may indicate the type of event that has occurred at the NAS triggering the accounting request message. For example, Acct-Status-Type AVP 630 may indicate that a session or flow of traffic has stopped. In various exemplary embodiments, session management node 160 may accumulate subscriber usage when it receives an accounting message indicating the session or flow has stopped.

Vendor-Specific AVP 640 may be an AVP that follows a vendor customized format for providing additional information. Vendor-Specific AVP 640 may include additional fields and/or AVPs or format the information using another method. As an example, Vendor-Specific AVP 640 may include Vendor-ID field 650 and QID field 660. Vendor-ID field 650 may be a field that identifies the vendor of the NAS. The identity of the vendor may be useful in further decoding the Vendor-Specific AVP 640. QID field 660 may be a field for a vendor customized piece of information that may not otherwise follow the communication protocol. For example, QID field 660 may indicate a QoS level of 3 associated with the usage information in the accounting message. Various vendors may provide different information in Vendor-Specific AVP 640. For example, a second vendor may include Vendor-ID field 650, but include a field for service type rather than QID. For example, the second vendor may describe the service type using a string such as, “VIDEO.” Even if vendors do use the same fields, different vendors may use different value scales to describe the type of usage. For example, a QoS level of 3 for one vendor may be the equivalent of a QoS level of 5 for another vendor.

Acct-Input-Octets AVP 670 may be an AVP that indicates a measured amount of usage reported for the subscriber in the accounting message. Acct-Input-Octets AVP 670 may measure the number of octets of data received by the subscriber being reported by the accounting message. Similarly, Acct-Output-Octets AVP 680 may be an AVP that indicates a measured amount of usage reported for the subscriber in the accounting message. Acct-Output-Octets 680 may measure the number of octets of data sent by the subscriber being reported by the accounting message. Other AVPs may be included in message 600 to report the subscriber's usage according to other metrics such as, for example, number of packets or session time.

FIG. 7 illustrates an exemplary data structure 700 for storing NAS profiles. Although data structure 700 is shown as a table, it should be apparent that other data structures for storing similar data may be used. Data structure 700 may include fields such as NAS-Identifier field 705, attribute field 710, Vendor-ID field 715, value field 720, monitoring key field 725, and rating field 730. Data structure 700 may include one or more entries 740a . . . n for storing data. Data structure 700 may be stored in a machine-readable storage medium of session management node 160, for example, NAS profile storage 220. The operator of session management node 160 may configure the entries of data structure 700. For example, the operator may add additional entries as new NAS nodes are added to the network. Data structure 700 may be used to determine a monitoring key and/or rating from an accounting request message.

NAS-Identifier field 705 may store an AVP that identifies the NAS that sent the accounting message. NAS-Identifier field 705 may be used to determine how to interpret an accounting request message. An entry under NAS-Identifier field 705 may include one or more names of NAS nodes with similar accounting message formats. An entry under NAS-Identifier field 705 may be associated with one or more of entries 740. For example, the first entry under NAS-Identifier field 705 may include four NAS nodes named: “0x3F3D”, “0x2B82”, “0x2942”, and “0xC274” and be associated with entries 740a-e. Alternatively, a full list for NAS-Identifier field 705 may be included in each entry 740.

Attribute field 710 may store one or more AVPs that may be present in an accounting request message and useful for determining the monitoring key and/or rating. Attribute field 710 may be compared to the AVPs in a received accounting message to determine which AVP(s) should be examined to determine a monitoring key and/or rating.

Vendor-ID field 715 may store a name or identifier for a NAS vendor. Vendor-ID field 715 may be used to determine how to interpret the contents of a Vendor-Specific AVP.

Value field 720 may store a value of an AVP within the received accounting request message. The value field 720 may be compared with the value of the AVP indicated by attribute field 710. In various alternative embodiments, an entry in value field 720 may include multiple values corresponding to multiple attributes in field 710.

Monitoring key field 725 may store an identifier for a monitoring key that should be associated with the received accounting message. As described above, the monitoring key may be used to record usage information for a subscriber.

Rating field 730 may store a rating factor that may be associated with a type of usage. The rating factor may be used to weight one type of usage against others when storing usage information or calculating cumulative usage. The rating factor may be associated with the monitoring key. Alternatively, the rating factor may be independent of the monitoring key and vary based on NAS, period of time, or accumulated usage. For example, a NAS dedicated to providing streaming video to an IPTV or remote DVR may provide a lower rating than a NAS providing streaming video over a general Internet connection. As another example, the rating may increase during a peak period of time.

Several examples of entries 740 within data structure 700 will now be described. Entries 740a-e may indicate that for an accounting message received from any of NAS nodes: “0x3F3D”, “0x2B82”, “0x2942”, or “0xC274”, the Vendor-Specific AVP should be examined according to the format of vendor “V1.” According to entry 740a, if the value of the Vendor-Specific AVP is “0”, a “DATA” monitoring key and rating of “1” may be assigned. According to entry 740b, if the value of the Vendor-Specific AVP is “1”, a “P2P” monitoring key and rating of “1.5” may be assigned. According to entry 740c, if the value of the Vendor-Specific AVP is “3”, an “AUDIO” monitoring key and rating of “2” may be assigned. According to entry 740d, if the value of the Vendor-Specific AVP is “3”, a “VOIP” monitoring key and rating of “2” may be assigned. According to entry 740e, if the value of the Vendor-Specific AVP is “4”, a “VIDEO” monitoring key and rating of “3” may be assigned.

Entries 740f-h may indicate that for an accounting message received from NAS node: “0x13B5”, the Vendor-Specific AVP should be examined according to the format of vendor “V2.” According to entry 740f, if the value of the Vendor-Specific AVP is “0”, a “VIDEO” monitoring key and rating of “3” may be assigned. According to entry 740g, if the value of the Vendor-Specific AVP is “1”, an “AUDIO” monitoring key and rating of “2” may be assigned. According to entry 740h, if the value of the Vendor-Specific AVP is “2”, a “DATA” monitoring key and rating of “1” may be assigned.

Entries 740i-k may indicate that for an accounting message received from NAS node: “0x4C82”, the Filter-Id AVP should be examined. According to entry 740i, if the value of the Vendor-Specific AVP is “VIDEO”, a “VIDEO” monitoring key and rating of “3” may be assigned. According to entry 740j, if the value of the Vendor-Specific AVP is “AUDIO”, an “AUDIO” monitoring key and rating of “2” may be assigned. According to entry 740k, if the value of the Vendor-Specific AVP is “DATA”, a “DATA” monitoring key and rating of “1” may be assigned.

Entry 740l may indicate that NAS node “0x6D39” only provides video services; therefore, a “VIDEO” monitoring key and rating of “2” may be assigned. Entry 740m may indicate that additional entries in data structure 700 are possible. Entry 740n may indicate that a “DATA” monitoring key and rating of “1” may be assigned as a default if no attribute can be used to determine a monitoring key and/or rating.

FIG. 8 illustrates a flowchart showing an exemplary method 800 for determining a monitoring key. Method 800 may be performed by the various components of session management node 160 such as receiver 205, usage reporter 215, NAS profile storage 220, and session information storage 230. The method 800 may begin at step 805 and proceed to step 810.

In step 810, session management node 160 may receive an accounting message from a NAS node via receiver 205. The accounting message may be similar to accounting message 600. In various alternative embodiments, the accounting message may use a different protocol and/or include different fields of information. Session management node 160 may perform checks to ensure that the message was received correctly. The method may then proceed to step 815.

In step 815, session management node 160 may identify the NAS that sent the message. Session management node 160 may identify the NAS by extracting a NAS-Identifier field from the message. The session management node 160 may also identify the NAS using an IP address or other identifier. The method may then proceed to step 820.

In step 820, the session management node 160 may identify an attribute that indicates a type of usage. Session management node 160 may look up the identified NAS in field 705 of data structure 700 to determine which attribute the NAS uses to indicate type of usage. The method may then proceed to step 825.

In step 825, the session management node 160 may determine whether the identified attribute is a vendor specific attribute. If the identified attribute is vendor specific, the method 800 may proceed to step 830. If the identified attribute is not vendor specific, the method 800 may proceed to step 835.

In step 830, the session management node 160 may identify the vendor. In various exemplary embodiments such as, for example, those using RADIUS, session management node 160 may extract a Vendor-Id AVP from the Vendor-Specific AVP. In various alternative embodiments, session management node may need to use another method based on the known NAS to identify the vendor. Session management node 160 may use the vendor identity to decode the vendor specific attribute. The method 800 may then proceed to step 835.

In step 835, session management node 160 may identify a monitoring key based on the attribute value. Session management node 160 may look up the attribute value in field 720 of data structure 700. Session management node 160 may identify the monitoring key in field 725 associated with the attribute. The method may then proceed to step 840, where session management node 160 may identify the rating in field 730 associated with the attribute.

Having described accounting message 600, data structure 700, and method 800, an example of the operation of session management node 160 will now be described. Session management node 160 may receive a RADIUS Accounting-Request message 600 from a NAS via receiver 205. Receiver 205 may pass the message 600 to usage reporter 215. Usage reporter 215 may determine that message 600 includes usage information based on the presence and values of Acct-Status-Type AVP 630, Acct-Input-Octets AVP 670, and Acct-Output-Octets AVP 680. Usage reporter 215 may then query NAS profile storage 220 with the message 600. Usage reporter 610 may look up the NAS-Identifier value “0x3F3D” of message 600 in the NAS-Identifier field 705. Data structure 700 indicates that NAS “0x3F3D” uses a Vendor-Specific attribute to indicate the type of usage. Alternatively, the presence of a Vendor-Specific attribute within an accounting message 600 may indicate that the Vendor-Specific attribute indicates the type of usage. Usage reporter 115 may then extract the Vendor-ID field 650 from the Vendor-Specific AVP 640. Usage reporter 215 may use this information to extract QID field 660 and determine that the value is 3. Usage reporter 215 may then look up the Vendor-Specific AVP, Vendor-ID field, and value of 3 in data structure 700 to determine that the monitoring key should be VOIP and the rating factor should be 2. Usage reporter 215 may then update the subscriber information associated with Acct-Session-ID “0x0B32” by adding the Acct-Input-Octets AVP 670 and Acct-Output-Octets AVP 690 to the accumulated usage for the subscriber's accumulated usage for the VOIP monitoring key. In various alternative embodiments, usage reporter 215 may multiply the usage by the rating factor of 2 before adding it to the accumulated usage.

According to the foregoing, various exemplary embodiments provide for a system and method for adjusting subscriber QoS based on subscriber usage and current time period. In particular, by mapping accounting messages to monitoring keys, subscriber usage may be uniformly tracked according to type of usage. Metering policies and rules may be used to authorize subscriber QoS according to changing usage information and changing time periods. A system operator may configure policy and rules to control QoS to meet subscriber demand and allocate network resources.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A session management node comprising:
a receiver configured to receive, from a network access server (NAS), an accounting message that indicates a network usage of a subscriber, the accounting message including at least one field;
a NAS profile configured to map the accounting message to a type of usage based on the at least one field;
a session information storage that includes a record of an accumulated network usage of the subscriber, the record including accumulated usage for the type of usage; and
a usage reporter configured to update the subscriber's accumulated network usage in the session information storage for the type of usage corresponding to the accounting message.

2. The session management node of claim 1, wherein the accounting message is a RADIUS Accounting-Request message and the at least one field is at least one AVP.

3. The session management node of claim 2, wherein the at least one AVP is a Vendor-Specific AVP including a Vendor-Id field and an attribute specific field, and the NAS profile is configured to map the accounting message to a monitoring key based on the attribute specific field.

4. The method of claim 3, wherein the attribute specific field indicates a Quality of Service (QoS) that the NAS provided for the network usage of the subscriber.

5. The session management node of claim 1, wherein the receiver is configured to receive at least one accounting message from each of at least two different NAS servers; and the NAS profile is configured to map the accounting message from each NAS server to the same type of usage based on a different field in each accounting message.

6. The session management node of claim 1, wherein the type of usage is associated with a monitoring key, the monitoring key associated with at least one threshold amount of usage for the type of usage and a policy to be applied if the subscriber's accumulated network usage exceeds the threshold.

7. The session management node of claim 6, wherein the monitoring key is associated with a rating factor and the usage reporter multiplies the network usage of the subscriber by the rating factor.

8. A method of measuring network usage of a subscriber, the method comprising:
receiving, at a session management node, from a Network Access Server (NAS), an accounting message that indicates an amount of network usage of a subscriber, the accounting message including at least one field;
determining a type of usage based on the at least one field using a NAS profile; and
monitoring the usage of the subscriber by adding the amount of network usage to an accumulated usage for the type of usage for the subscriber.

9. The method of claim 8, wherein the accounting message is a RADIUS Accounting-Request message and the at least one field is at least one attribute value pair (AVP).

10. The method of claim 9, wherein the at least one AVP includes a Vendor-Specific AVP and the NAS profile includes at least two AVPs that map to the same type of usage.

11. The method of claim 8, wherein the type of usage is associated with a monitoring key corresponding to a threshold amount of usage and a policy to be applied if the subscriber's accumulated usage exceeds the threshold, the method further comprising:
if the accumulated usage for the type of usage for the subscriber exceeds the threshold amount of usage for the monitoring key, applying the policy for the monitoring key to the subscriber;
authorizing a QoS for the subscriber based at least on the policy applied to the subscriber; and
transmitting an authorization message to the NAS indicating the QoS that the NAS should provide to the subscriber.

12. The method of claim 8, wherein the step of determining a type of usage comprises:
identifying the NAS that sent the accounting request;
identifying a field among the at least one field that indicates a type of usage based on the identified NAS;
determining whether the field is a vendor specific field; and
if the field is a vendor specific field:
identifying the vendor of the identified NAS, and determining the monitoring key based on the vendor and a sub-field of the vendor specific field.

13. The method of claim 8 further comprising: determining a rating factor for the amount of usage based on the type of usage; and multiplying the amount of usage by the rating factor.

14. A tangible and non-transitory machine-readable storage medium encoded with instructions for measuring network usage of a subscriber, the machine-readable storage medium comprising:
instructions for receiving, at a session management node, from a Network Access Server (NAS), an accounting message that indicates an amount of network usage of a subscriber, the accounting message including at least one field;
instructions for determining a type of usage based on the at least one field using a NAS profile; and
instructions for monitoring the usage of the subscriber by adding the amount of network usage to an accumulated usage for the type of usage for the subscriber.

15. The tangible and non-transitory machine-readable storage medium of claim 14, wherein the accounting message is a RADIUS Accounting-Request message and the at least one field is at least one attribute value pair (AVP).

16. The tangible and non-transitory machine-readable storage medium of claim 15, wherein the at least one AVP includes a Vendor-Specific AVP and the NAS profile includes at least two AVPs that map to the same type of usage.

17. The tangible and non-transitory machine-readable storage medium of claim 14, wherein the type of usage is associated with a monitoring key corresponding to a threshold amount of usage and a policy to be applied if the subscriber's accumulated usage exceeds the threshold, the machine-readable storage medium further comprising:
instructions for applying the policy for the monitoring key to the subscriber if the accumulated usage for the type of usage for the subscriber exceeds the threshold amount of usage for the monitoring key;
instructions for authorizing a QoS for the subscriber based at least on the policy applied to the subscriber; and
instructions for transmitting an authorization message to the NAS indicating the QoS that the NAS should provide to the subscriber.

18. The tangible and non-transitory machine-readable storage medium of claim 14, wherein the instructions for determining a type of usage comprise:
instructions for identifying the NAS that sent the accounting request;
instructions for identifying a field among the at least one field that indicates a type of usage based on the identified NAS;
instructions for determining whether the field is a vendor specific field; and
instructions for identifying the vendor of the identified NAS and determining the monitoring key based on the vendor and a sub-field of the vendor specific field if the field is a vendor specific field.

19. The tangible and non-transitory machine-readable storage medium of claim 14 further comprising: instructions for determining a rating factor for the amount of usage based on the type of usage; and instructions for multiplying the amount of usage by the rating factor.

20. The tangible and non-transitory machine-readable storage medium of claim 19 wherein the instructions for determining a rating factor further comprise instructions for increasing the rating factor based on a current time period.
